(19) United States
(12) Patent Application Publication
(10) Pub. No.: US 2007/0097596 A1
(43) Pub. Date: May 3, 2007

(54) Thin-film device and method of manufacturing same

(75) Inventors: Hajime Kuwajima, Tokyo (JP); Masahiro Miyazaki, Tokyo (JP); Akira Furuya, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/583,067

(22) Filed: Oct. 19, 2006

(30) Foreign Application Priority Data
Oct. 31, 2005 (JP) 2005-316293

(51) Int. Cl. H01G 4/06

(52) U.S. Cl. 361/311

(57) ABSTRACT

A thin-film device comprises a substrate and a capacitor provided on the substrate. The capacitor incorporates: a lower conductor layer disposed on the substrate; a dielectric film disposed on the lower conductor layer; and an upper conductor layer disposed on the dielectric film. The thickness of the dielectric film falls within a range of 0.02 to 1 μm inclusive and is smaller than the thickness of the lower conductor layer. The surface roughness in maximum height of the top surface of the lower conductor layer is equal to or smaller than the thickness of the dielectric film.

### BACKGROUND OF THE INVENTION

1. Field of the Invention

The present invention relates to a thin-film device comprising a capacitor and a method of manufacturing such a thin-film device.

2. Description of the Related Art

With increasing demands for reductions in dimensions and thickness of high frequency electronic apparatuses such as cellular phones, reductions in dimensions and profile of electronic components mounted on the high frequency electronic apparatuses have been sought. Some of the electronic components comprise capacitors. Each capacitor typically incorporates a dielectric layer and a pair of conductor layers disposed to sandwich the dielectric layer.

To achieve reductions in dimensions and profile of an electronic component comprising a capacitor, important factors are a reduction in area of a region in which the pair of conductor layers are opposed to each other with the dielectric layer disposed in between and a reduction in the number of layers making up the capacitor. Basically, in prior art, a material having a high permittivity is used as a dielectric material forming the dielectric layer and the thickness of the dielectric layer is reduced to achieve a reduction in area of the above-mentioned region and a reduction in the number of the layers making up the capacitor.

As conventional electronic components comprising capacitors, a thin-film capacitor disclosed in Japanese Published Patent Application (hereinafter referred to as “JP-A”) 2003-347155 and a thin-film capacitor element disclosed in JP-A 2003-17366 are known. The thin-film capacitor disclosed in JP-A 2003-347155 incorporates a lower electrode layer, a dielectric layer and an upper electrode layer formed one by one on a substrate through the use of thin-film forming techniques. The thin-film capacitor element disclosed in JP-A 2003-17366 incorporates a lower electrode, a dielectric layer and an upper electrode formed one by one on a substrate through the use of thin-film forming techniques. JP-A 2003-17366 discloses a technique in which the top surface of the lower electrode and that of an insulator layer disposed around the lower electrode are flattened to form the dielectric layer on the flattened top surfaces. An electronic component formed through thin-film forming techniques such as the above-mentioned thin-film capacitor and thin-film capacitor element is called a thin-film device in the present patent application.

JP-A 11-168306 discloses an element comprising: a dielectric substrate; a multilayer thin-film electrode made up of thin-film conductor layers and thin-film dielectric layers alternately stacked on the dielectric substrate with a bonding layer disposed between every adjacent thin-film conductor layer and thin-film dielectric layer; and a flattening film disposed between the dielectric substrate and the multilayer thin-film electrode. In this element, a surface of the flattening film that touches the multilayer thin-film electrode has been polished for flattening.

Since the dielectric layer of the thin-film device comprising a capacitor is formed through thin-film forming techniques, it is possible to reduce the thickness of the dielectric layer and to thereby reduce the profile of the thin-film device. However, if the thickness of the dielectric layer is reduced in the thin-film device comprising a capacitor, there arise such problems that the withstand voltage of the capacitor is reduced and that variations in withstand voltage of the capacitor among products are increased. These problems will now be described in detail with reference to FIG. 25.

FIG. 25 is a cross-sectional view illustrating an example of configuration of a thin-film device comprising a capacitor. The thin-film device of FIG. 25 comprises: a lower conductor layer 102 disposed on a substrate 101; a dielectric layer 103 disposed on the substrate 101 and the lower conductor layer 102; and an upper conductor layer 104 disposed in a region sandwiching the dielectric layer 103 with the lower conductor layer 102. The thin-film device is fabricated by forming the lower conductor layer 102, the dielectric layer 103 and the upper conductor layer 104 in this order on the substrate 101 through the use of thin-film forming techniques.

In the thin-film device of FIG. 25, if the surface roughness of the top surface of the lower conductor layer 102 is great, the thickness of the dielectric layer 103 is made nonuniform. Consequently, a portion whose thickness is particularly small is created in the dielectric layer 103, and insulation in this portion is reduced, which may result in an extreme reduction in withstand voltage of the capacitor. In such a case, it is likely that a short-circuit failure of the capacitor caused by a puncture of the dielectric layer 103, for example, occurs. Furthermore, if the thickness of the dielectric layer 103 is made nonuniform, variations in withstand voltage of the capacitor among products are increased.

In a case in which the thin-film device comprising a capacitor is designed for high frequency applications, if the surface roughness of the top surface of the lower conductor layer 102 is great, the skin resistance of the lower conductor layer 102 increases, and the signal transmission characteristic of the lower conductor layer 102 may be thereby degraded.

It is required that the lower conductor layer 102 have a certain thickness so that a sufficient current can be fed thereto. Therefore, electroplating is used, for example, as a method of forming the lower conductor layer 102. In this case, it is likely that the surface roughness of the top surface of the lower conductor layer 102 is particularly made great, and the above-described problem is noticeable.

As described above, JP-A 2003-17366 teaches flattening the top surface of the lower electrode and that of the insulator layer disposed around the lower electrode and forming the dielectric layer on the flattened top surfaces. However, this publication does not teach the allowable degree of surface roughness of the top surface of the lower electrode in relation to the thickness of the dielectric layer.

The technique disclosed in JP-A 11-168306 is provided to flatten the surface of the flattening film to touch the multilayer thin-film electrode, the flattening film serving as the base of the multilayer thin-film electrode, and not to flatten the top surface of the multilayer thin-film electrode.

### OBJECT AND SUMMARY OF THE INVENTION

It is an object of the invention to provide a thin-film device comprising a capacitor, the thin-film device being capable of suppressing a reduction in withstand voltage of the capacitor and an increase in variation in withstand voltage of the capacitor among products, and to provide a method of manufacturing such a thin-film device.

A first thin-film device of the invention comprises a capacitor. The capacitor incorporates: a lower conductor layer; a dielectric film disposed on the lower conductor layer; and an upper conductor layer disposed on the dielectric film. The dielectric film has a thickness that falls within a range of 0.02 to 1 μm inclusive and that is smaller than the thickness of the lower conductor layer. The surface roughness in maximum height of the top surface of the lower conductor layer is equal to or smaller than the thickness of the dielectric film.

According to the first thin-film device of the invention, the surface roughness in maximum height of the top surface of the lower conductor layer is equal to or smaller than the thickness of the dielectric film, so that the thickness of the dielectric film disposed on the lower conductor layer is made uniform.

A second thin-film device of the invention comprises a capacitor. The capacitor incorporates: a lower conductor layer; a flattening film made of a conductive material and disposed on the lower conductor layer; a dielectric film disposed on the flattening film; and an upper conductor layer disposed on the dielectric film. The dielectric film has a thickness that falls within a range of 0.02 to 1 μm inclusive and that is smaller than the thickness of the lower conductor layer. The surface roughness in maximum height of the top surface of the flattening film is equal to or smaller than the thickness of the dielectric film.

According to the second thin-film device of the invention, the surface roughness in maximum height of the top surface of the flattening film is equal to or smaller than the thickness of the dielectric film, so that the thickness of the dielectric film disposed on the flattening film is made uniform.

A third thin-film device of the invention comprises a capacitor. The capacitor incorporates: a lower conductor layer; a flattening film made of an insulating material and disposed on the lower conductor layer; a dielectric film disposed on the flattening film; and an upper conductor layer disposed on the dielectric film. The dielectric film has a thickness that falls within a range of 0.02 to 1 μm inclusive and that is smaller than the thickness of the lower conductor layer. The surface roughness in maximum height of the top surface of the flattening film is equal to or smaller than the thickness of the dielectric film.

According to the third thin-film device of the invention, the surface roughness in maximum height of the top surface of the flattening film is equal to or smaller than the thickness of the dielectric film, so that the thickness of the dielectric film disposed on the flattening film is made uniform.

A thin-film device manufactured through a first method of manufacturing a thin-film device of the invention comprises a capacitor. The capacitor incorporates: a lower conductor layer; a dielectric film disposed on the lower conductor layer; and an upper conductor layer disposed on the dielectric film. The dielectric film has a thickness that falls within a range of 0.02 to 1 μm inclusive and that is smaller than the thickness of the lower conductor layer.

The first method of the invention comprises the steps of forming the lower conductor layer by electroplating; flattening the top surface of the lower conductor layer so that the surface roughness in maximum height of the top surface of the lower conductor layer is equal to or smaller than the thickness of the dielectric film; forming the dielectric film on the lower conductor layer flattened; and forming the upper conductor layer on the dielectric film.

According to the first method of manufacturing the thin-film device of the invention, the top surface of the lower conductor layer is flattened so that the surface roughness in maximum height of the top surface of the lower conductor layer is equal to or smaller than the thickness of the dielectric film. The thickness of the dielectric film disposed on the lower conductor layer is thereby made uniform.

In the first method of the invention, the step of flattening the top surface of the lower conductor layer may include the step of polishing the top surface of the lower conductor layer. In this case, chemical mechanical polishing may be employed in the step of polishing the top surface of the lower conductor layer.

A thin-film device manufactured through a second method of manufacturing a thin-film device of the invention comprises a capacitor. The capacitor incorporates: a lower conductor layer; a flattening film made of a conductive material and disposed on the lower conductor layer; a dielectric film disposed on the flattening film; and an upper conductor layer disposed on the dielectric film. The dielectric film has a thickness that falls within a range of 0.02 to 1 μm inclusive and that is smaller than the thickness of the lower conductor layer. The surface roughness in maximum height of the top surface of the flattening film is equal to or smaller than the thickness of the dielectric film.

The second method of the invention comprises the steps of forming the lower conductor layer by electroplating; forming the flattening film on the lower conductor layer; forming the dielectric film on the flattening film; and forming the upper conductor layer on the dielectric film.

According to the second method of manufacturing the thin-film device of the invention, the surface roughness in maximum height of the top surface of the flattening film is equal to or smaller than the thickness of the dielectric film, so that the thickness of the dielectric film disposed on the flattening film is made uniform.

The second method of the invention may further comprise the step of polishing the top surface of the flattening film, the step being performed after the step of forming the flattening film and before the step of forming the dielectric film.

The second method of the invention may further comprise the step of polishing the top surface of the lower conductor layer, the step being performed after the step of forming the lower conductor layer and before the step of forming the flattening film.

In the second method of the invention, the flattening film may be formed by any of electroplating, physical vapor deposition, and chemical vapor deposition in the step of forming the flattening film.

A thin-film device manufactured through a third method of manufacturing a thin-film device of the invention comprises a capacitor. The capacitor incorporates: a lower conductor layer; a flattening film made of an insulating material and disposed on the lower conductor layer; a dielectric film disposed on the flattening film; and an upper conductor layer disposed on the dielectric film. The dielectric film has a thickness that falls within a range of 0.02 to 1 μm inclusive and that is smaller than the thickness of the lower conductor layer. The surface roughness in maximum height of the top surface of the flattening film is equal to or smaller than the thickness of the dielectric film.

The third method of the invention comprises the steps of forming the lower conductor layer by electroplating; forming the flattening film on the lower conductor layer; forming the dielectric film on the flattening film; and forming the upper conductor layer on the dielectric film.

According to the third method of manufacturing the thin-film device of the invention, the surface roughness in maximum height of the top surface of the flattening film is equal to or smaller than the thickness of the dielectric film, so that the thickness of the dielectric film disposed on the flattening film is made uniform.

The third method of the invention may further comprise the step of polishing the top surface of the lower conductor layer, the step being performed after the step of forming the lower conductor layer and before the step of forming the flattening film.

In the third method of the invention, in the step of forming the flattening film, the flattening film may be formed by applying a material to form the flattening film to the top of the lower conductor layer.

According to the first thin-film device or the first method of manufacturing the thin-film device of the invention, the surface roughness in maximum height of the top surface of the lower conductor layer is equal to or smaller than the thickness of the dielectric film, so that the thickness of the dielectric film disposed on the lower conductor layer is made uniform. As a result, the invention makes it possible to suppress a reduction in withstand voltage of the capacitor and an increase in variation in withstand voltage of the capacitor among products.

According to the second or third thin-film device or the second or third method of manufacturing the thin-film device of the invention, the surface roughness in maximum height of the top surface of the flattening film is equal to or smaller than the thickness of the dielectric film, so that the thickness of the dielectric film disposed on the flattening film is made uniform. As a result, the invention makes it possible to suppress a reduction in withstand voltage of the capacitor and an increase in variation in withstand voltage of the capacitor among products.

Other and further objects, features and advantages of the invention will appear more fully from the following description.

### BRIEF DESCRIPTION OF THE DRAWINGS

FIG. 1 is a cross-sectional view of a thin-film device of a first embodiment of the invention.

FIG. 2 is a cross-sectional view illustrating a step of a method of manufacturing the thin-film device of the first embodiment of the invention.

FIG. 3 is a cross-sectional view illustrating a step that follows the step of FIG. 2.

FIG. 4 is a cross-sectional view illustrating a step that follows the step of FIG. 3.

FIG. 5 is a cross-sectional view illustrating a step that follows the step of FIG. 4.

FIG. 6 is a cross-sectional view illustrating a step that follows the step of FIG. 5.

FIG. 7 is a cross-sectional view illustrating a step that follows the step of FIG. 6.

FIG. 8 is a cross-sectional view illustrating a step that follows the step of FIG. 7.

FIG. 9 is a cross-sectional view illustrating a step that follows the step of FIG. 8.

FIG. 10 is a plot showing the relationship between the percent defective of the capacitor and the surface roughness in maximum height of the top surface of the lower conductor layer of the first embodiment of the invention.

FIG. 11 is a cross-sectional view illustrating a step of a method of manufacturing a thin-film device of a second embodiment of the invention.

FIG. 12 is a cross-sectional view illustrating a step that follows the step of FIG. 11.

FIG. 13 is a cross-sectional view illustrating a step that follows the step of FIG. 12.

FIG. 14 is a cross-sectional view illustrating a step that follows the step of FIG. 13.

FIG. 15 is a cross-sectional view illustrating a step that follows the step of FIG. 14.

FIG. 16 is a cross-sectional view illustrating a step of a method of manufacturing a thin-film device of a third embodiment of the invention.

FIG. 17 is a cross-sectional view illustrating a step that follows the step of FIG. 16.

FIG. 18 is a cross-sectional view illustrating a step that follows the step of FIG. 17.

FIG. 19 is a cross-sectional view illustrating a step that follows the step of FIG. 18.

FIG. 20 is a cross-sectional view illustrating a step that follows the step of FIG. 19.

FIG. 21 is a cross-sectional view illustrating a step that follows the step of FIG. 20.

FIG. 22 is a cross-sectional view illustrating a step of a method of manufacturing a thin-film device of a fourth embodiment of the invention.

FIG. 23 is a cross-sectional view illustrating a step that follows the step of FIG. 22.

FIG. 24 is a cross-sectional view illustrating a step that follows the step of FIG. 23.

FIG. 25 is a cross-sectional view illustrating an example of configuration of a thin-film device comprising a capacitor.

### DESCRIPTION OF PREFERRED EMBODIMENTS

Preferred embodiments of the invention will now be described with reference to the accompanying drawings.

[First Embodiment]

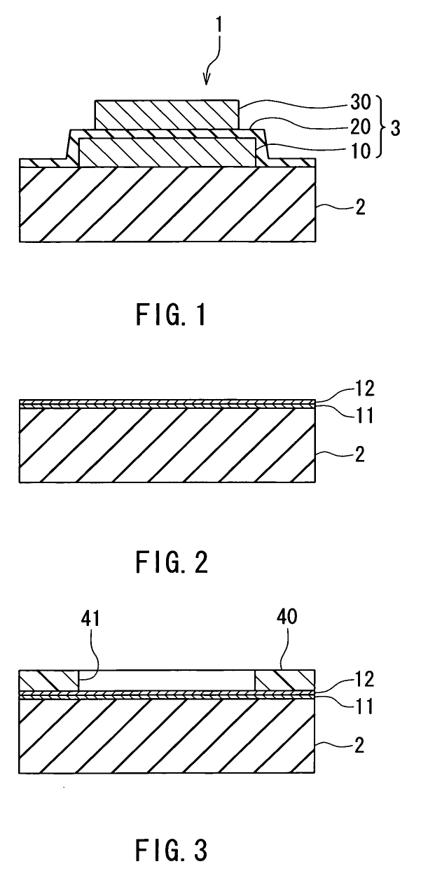

Reference is now made to FIG. 1 to describe a thin-film device of a first embodiment of the invention. FIG. 1 is a cross-sectional view of the thin-film device of the embodiment. As shown in FIG. 1, the thin-film device 1 of the embodiment comprises a substrate 2 and a capacitor provided on the substrate 2. The capacitor 3 incorporates: a lower conductor layer 10 disposed on the substrate 2; a dielectric film 20 disposed on the lower conductor layer 10; and an upper conductor layer 30 disposed on the dielectric film 20.

Each of the lower conductor layer 10 and the upper conductor layer 30 is patterned into a specific shape. The dielectric film 20 is disposed to cover the top and side surfaces of the lower conductor layer 10 and the top surface of the substrate 2. The upper conductor layer 30 is disposed in a region sandwiching the dielectric film 20 with the lower conductor layer 10. The lower conductor layer 10 and the upper conductor layer 30 make up a pair of electrodes opposed to each other with the dielectric film 20 disposed in between in the capacitor 3.

The substrate 2 is made of an insulating material (a dielectric material). The insulating material forming the substrate 2 may be an inorganic material or an organic material. The insulating material forming the substrate 2 may be Al₂O₃, for example.

The lower conductor layer 10 and the upper conductor layer 30 are made of a conductive material such as Cu. The dielectric film 20 is made of a dielectric material. The dielectric material forming the dielectric film 20 is preferably an inorganic material. The dielectric material forming the dielectric film 20 may be any of Al₂O₃, Si₄N₃ and SiO₂, for example.

The thickness of the dielectric film 20 falls within a range of 0.02 to 1 μm inclusive, and is smaller than the thickness of the lower conductor layer 10. The thickness of the dielectric film 20 preferably falls within a range of 0.05 to 0.5 μm inclusive. The thickness of the lower conductor layer 10 preferably falls within a range of 5 to 10 μm inclusive. The thickness of the upper conductor layer 30 preferably falls within a range of 5 to 10 μm inclusive.

The reason why it is preferred that the thicknesses of the lower conductor layer 10 and the upper conductor layer 30 fall within the above-mentioned ranges will now be described. The thin-film device of the embodiment is used in a band-pass filter for a wireless local area network (LAN) or for a cellular phone. For the wireless LAN a frequency band of 2.5 GHz is used. Considering the passing loss in this frequency band, it is required that the thickness of each of the lower conductor layer 10 and the upper conductor layer 30 be 3 μm or greater. That is, if the thickness of each of the lower conductor layer 10 and the upper conductor layer 30 is smaller than 3 μm, the passing loss will be too great. In addition, a frequency band of 800 MHz to 1.95 GHz is used for cellular phones. To improve the attenuation characteristic of the band-pass filter and to suppress noise at low frequencies in this frequency band in particular, it is required that the thickness of each of the lower conductor layer 10 and the upper conductor layer 30 be 5 μm or greater. Therefore, it is preferred that the thickness of each of the lower conductor layer 10 and the upper conductor layer 30 be 5 μm or greater. On the other hand, if each of the lower conductor layer 10 and the upper conductor layer 30 is too thick, the surface roughness of the top surface of each of the lower conductor layer 10 and the upper conductor layer 30 is increased and the skin resistance of each of the lower conductor layer 10 and the upper conductor layer 30 is thereby increased, or it becomes necessary to perform flattening processing for reducing the surface roughness of the top surface of each of the lower conductor layer 10 and the upper conductor layer 30, which requires time and labor. Therefore, it is practically preferred that the thickness of each of the lower conductor layer 10 and the upper conductor layer 30 be 10 μm or smaller.

In the embodiment it is defined that the surface roughness in maximum height Rz of the top surface of the lower conductor layer 10 is equal to or smaller than the thickness of the dielectric film 20. The surface roughness in maximum height Rz is one of parameters indicating the surface roughness and is defined as a sum of the maximum value of the peak and the maximum value of the valley of a contour curve of a unit length.

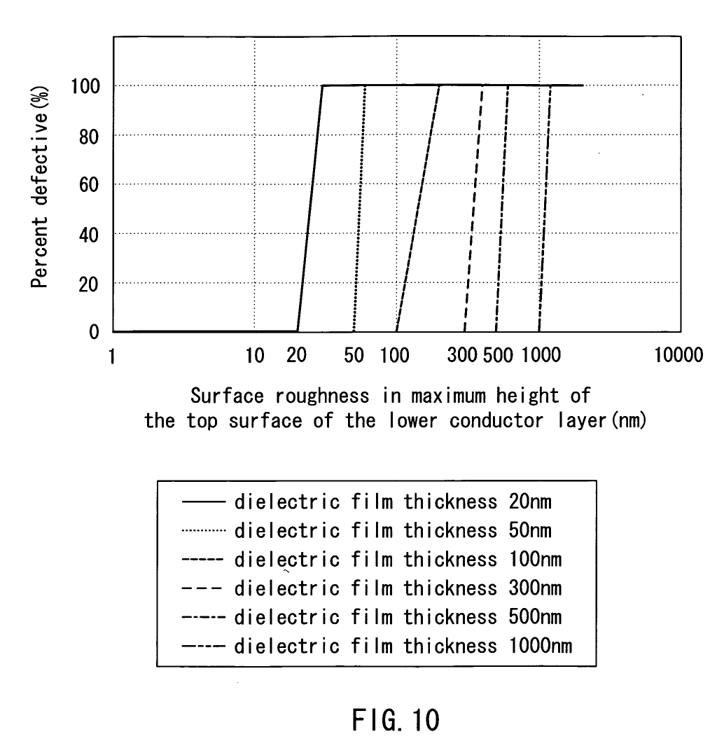

The above-mentioned relationship between the surface roughness in maximum height Rz of the top surface of the lower conductor layer 10 and the thickness of the dielectric film 20 is defined based on the result of an experiment that will now be described. In the experiment, first, a number of samples of the capacitor 3 were fabricated, the samples being different in thickness of the dielectric film 20 and in surface roughness in maximum height Rz of the top surface of the lower conductor layer 10. The percent defective of the capacitor 3 in terms of short-circuit failures was measured for each of the samples, wherein the percent defective was defined as a percentage of occurrences of short-circuit failures of the capacitor 3 when a voltage of 3 volts was applied to each of the samples. The dielectric film 20 of each of the samples had a thickness of any of six types, that is, 20 nm, 50 nm, 100 nm, 300 nm, 500 nm and 1000 nm. The surface roughness in maximum height Rz of the top surface of the lower conductor layer 10 of each of the samples fell within a range of 1 to 2000 nm inclusive. FIG. 10 shows the result of the experiment. FIG. 10 is a plot showing the relationship between the percent defective of the capacitor 3 and the surface roughness in maximum height Rz of the top surface of the lower conductor layer 10.

As shown in FIG. 10, in cases where the thickness of the dielectric film 20 is any of the above-mentioned six types, a short-circuit failure of the capacitor 3 may occur if the surface roughness in maximum height Rz of the top surface of the lower conductor layer 10 is greater than the thickness of the dielectric film 20, whereas no short-circuit failure of the capacitor 3 will occur if the surface roughness in maximum height Rz of the top surface of the lower conductor layer 10 is equal to or smaller than the thickness of the dielectric film 20. This teaches that, as long as the surface roughness in maximum height Rz of the top surface of the lower conductor layer 10 is equal to or smaller than the thickness of the dielectric film 20, it is possible to prevent a short-circuit failure of the capacitor 3 caused by, for example, a puncture of the dielectric film 20 resulting from a reduction in withstand voltage of the capacitor 3. Because of the foregoing, the embodiment requires that the surface roughness in maximum height Rz of the top surface of the lower conductor layer 10 be equal to or smaller than the thickness of the dielectric film 20.

Reference is now made to FIG. 2 to FIG. 9 to describe a method of manufacturing the thin-film device 1 of the embodiment. Although examples of materials and thicknesses of the layers are given in the following description, those examples are non-limiting for the method of the embodiment.

FIG. 2 is a cross-sectional view illustrating a step of the method of manufacturing the thin-film device 1 of the embodiment. In the method, first, as shown in FIG. 2, a first electrode film 11 and a second electrode film 12 are formed one by one on the substrate 2 by sputtering, for example. The electrode films 11 and 12 will be used as electrodes when a plating film is formed by electroplating later and will make up part of the lower conductor layer 10. The material of the first electrode film 11 is Ti, for example. The thickness of the first electrode film 11 is 5 nm, for example. The material of the second electrode film 12 is Cu or Ni, for example. The thickness of the second electrode film 12 is 100 nm, for example. Alternatively, a single-layer electrode film may be formed in place of the electrode films 11 and 12.

FIG. 3 illustrates the following step. In the step, first, a photoresist layer having a thickness of 8 μm, for example, is formed on the electrode film 12. Next, the photoresist layer is patterned by photolithography to form a frame 40. The frame 40 has a groove 41 having a shape corresponding to the shape of the lower conductor layer 10 to be formed.

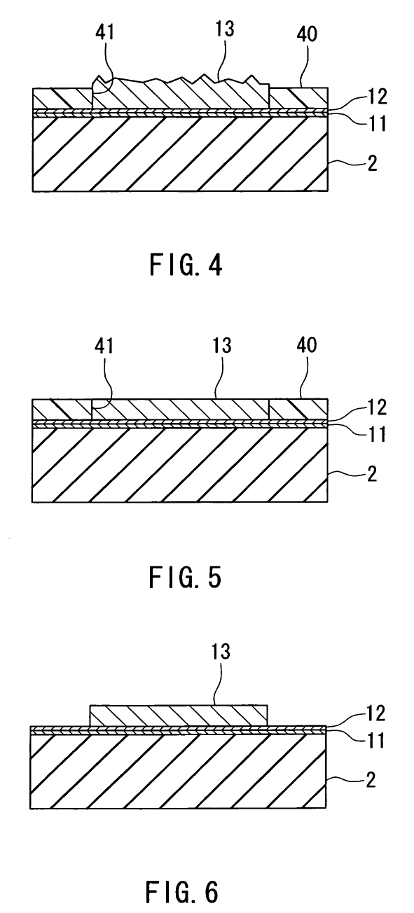

Next, as shown in FIG. 4, the plating film 13 is formed in the groove 41 by electroplating using the electrode films 11 and 12 as electrodes. The material of the plating film 13 is Cu, for example. The thickness of the plating film 13 is 9 to 10 μm, for example.

Next, as shown in FIG. 5, the top surface of the plating film 13 is flattened so that the surface roughness in maximum height Rz of the top surface of the plating film 13 is equal to or smaller than the thickness of the dielectric film 20 that will be formed later. For example, when the dielectric film 20 having a thickness of 0.1 μm is to be made, the top surface of the plating film 13 is flattened so that the surface roughness in maximum height Rz of the top surface of the plating film 13 is equal to or smaller than 0.1 μm.

The flattening processing of the embodiment is performed by polishing the top surface of the plating film 13. A method of this polishing is chemical mechanical polishing (CMP), for example. The polishing is performed such that the thickness of the plating film 13 flattened is 8 μm, for example. The method of polishing the top surface of the plating film 13 is not limited to CMP but may be any other polishing method such as buffing, lapping and die polishing. The processing of flattening the top surface of the plating film 13 may be performed by a combination of two or more polishing methods. Next, as shown in FIG. 6, the frame 40 is removed.

In the step shown in FIG. 4, if the plating film 13 is formed so that the thickness of the plating film 13 is greater than the thickness of the frame 40, portions of the plating film 13 out of the groove 41 of the frame 40 may be polished, and polishing may be stopped when the thickness of the plating film 13 coincides with that of the frame 40 in the step shown in FIG. 5. In this case, it is possible to precisely control the thickness of the lower conductor layer 10 formed of the plating film 13. Furthermore, if the amount of polishing of the frame 40 is great, the polishing device such as a grindstone may be loaded, and flattening of the top surface of the plating film 13 may be thereby disturbed. Such a failure can be prevented if the polishing is stopped when the thickness of the plating film 13 coincides with that of the frame 40.

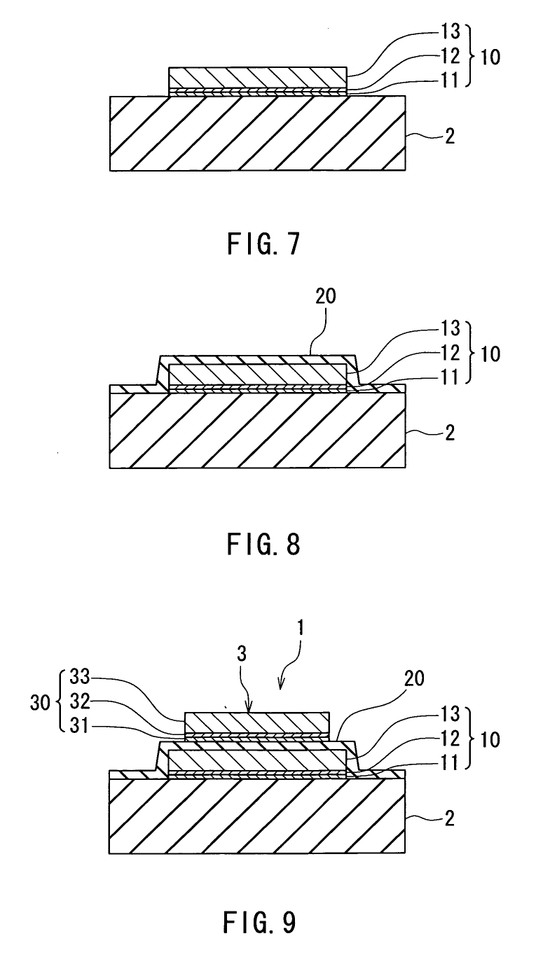

Next, as shown in FIG. 7, the electrode films 11 and 12 except portions thereof located below the plating film 13 are removed by dry etching or wet etching. As a result, the lower conductor layer 10 is formed of the remaining electrode films 11 and 12 and the plating film 13. If the material of each of the electrode film 12 and the plating film 13 is Cu, a portion of the plating film 13 is etched, too, when etching is performed to remove the electrode films 11 and 12. However, there is hardly any difference between the surface roughness of the top surface of the plating film 13 before this etching and that after this etching. If the material of the electrode film 12 is Ni and the material of the plating film 13 is Cu, a condition under which the plating film 13 is not etched is chosen for the etching for removing the electrode films 11 and 12. Since flattening processing is performed on the top surface of the top surface of the plating film 13 in the step shown in FIG. 5, the surface roughness in maximum height Rz of the top surface of the lower conductor layer 10 formed in the step shown in FIG. 7 is equal to or smaller than the thickness of the dielectric film 20 that will be formed later.

Next, as shown in FIG. 8, the dielectric film 20 is formed by sputtering, for example, to cover the top and side surfaces of the lower conductor layer 10 and the top surface of the substrate 2. The thickness of the dielectric film 20 is 0.1 μm, for example.

Next, as shown in FIG. 9, the upper conductor layer 30 is formed in a region that is on the dielectric film 20 and that sandwiches the dielectric film 20 with the lower conductor layer 10. A method of forming the upper conductor layer 30 is the same as that of the lower conductor layer 10 except the flattening processing. That is, electrode films 31 and 32 are first formed in this order on the dielectric film 20. The materials and thicknesses of the electrode films 31 and 32 are the same as those of the electrode films 11 and 12. Next, a photoresist layer having a thickness of 8 μm, for example, is formed on the electrode film 32. Next, the photoresist layer is patterned by photolithography to form a frame not shown. The frame has a groove having a shape corresponding to the shape of the upper conductor layer 30 to be formed. Next, a plating film 33 is formed in the groove by electroplating using the electrode films 31 and 32 as electrodes. The material of the plating film 33 is Cu, for example. The thickness of the plating film 33 is 8 μm, for example. Next, the frame is removed. Next, the electrode films 31 and 32 except portions thereof located below the plating film 33 are removed by dry etching or wet etching. As a result, the upper conductor layer 30 is formed of the remaining electrode films 31 and 32 and the plating film 33.

According to the embodiment as thus described, the top surface of the lower conductor layer 10 is flattened so that the surface roughness in maximum height Rz of the top surface of the lower conductor layer 10 is equal to or smaller than the thickness of the dielectric film 20, and the dielectric film 20 is formed on the flattened top surface of the lower conductor layer 10. Therefore, according to the embodiment, the uniformity of the thickness of the dielectric film 20 is better than the case in which the top surface of the lower conductor layer 10 is not flattened. As a result, it is possible to suppress a reduction in withstand voltage of the capacitor 3 and an increase in variation in withstand voltage of the capacitor 3 among products. For example, it is possible to make the withstand voltage of the capacitor 3 equal to or greater than 80 volts if the top surface of the lower conductor layer 10 is flattened as in the embodiment under a condition in which the withstand voltage of the capacitor 3 is equal to or smaller than 30 volts if the top surface of the lower conductor layer 10 is not flattened. Furthermore, according to the embodiment, since it is possible to suppress a reduction in withstand voltage of the capacitor 3, it is possible to prevent a short-circuit failure of the capacitor 3 caused by a puncture of the dielectric film 20, for example.

According to the embodiment, since the thickness of the dielectric film 20 is made uniform, it is possible to make the dielectric film 20 thin while maintaining a sufficient withstand voltage of the capacitor 3. As a result, in cases where capacitors having the same capacitances are to be implemented, it is possible to reduce the area of a region in which the lower conductor layer 10 and the upper conductor layer 30 are opposed to each other with the dielectric film 20 disposed in between and to reduce the number of conductor layers and dielectric films to be stacked. It is thereby possible to achieve reductions in dimensions and profile of the thin-film device.

Furthermore, according to the embodiment, since the surface roughness of the top surface of the lower conductor layer 10 is small, it is possible to reduce the skin resistance of the lower conductor layer 10. As a result, it is possible to prevent degradation of the signal transmission characteristic of the lower conductor layer 10 when the thin-film device 1 is designed for high frequency applications.

In the method of manufacturing the thin-film device 1 of the embodiment, the lower conductor layer 10 is formed by electroplating. However, the lower conductor layer 10 of the thin-film device 1 of the embodiment may be formed by a method other than electroplating. For example, the lower conductor layer 10 may be formed by physical vapor deposition (PVD) such as sputtering or evaporation. When the lower conductor layer 10 is formed by electroplating, it is preferred to adjust the sizes of precipitation grains by controlling the composition of plating bath and the current density. In addition, when the lower conductor layer 10 is formed by electroplating, it is preferred that, for suppressing a change in the surface roughness of the top surface of the lower conductor layer 10 with time, heat treatment be performed on the lower conductor layer 10 so that the lower conductor layer 10 is in equilibrium and then the dielectric film 20 be formed on the lower conductor layer 10. When the lower conductor layer 10 is formed by PVD, heat treatment of the lower conductor layer 10 is not required since it is nearly in the state of equilibrium.

In the embodiment, inverse sputtering may be performed before forming the dielectric film 20 to remove unwanted substances such as oxides and organic substances present on the surface of the lower conductor layer 10 and to activate the surface of the lower conductor layer 10 so as to improve the contact of the surface of the lower conductor layer 10 with the dielectric film 20. In this case, in particular, processing of improving the contact of the surface of the lower conductor layer 10 with the dielectric film 20 and processing of forming the dielectric film 20 may be performed consecutively in a single vacuum chamber, so that the contact of the lower conductor layer 10 with the dielectric film 20 is further improved.

It is also possible that, before forming the electrode film 11 or 31, inverse sputtering is performed to remove unwanted substances such as oxides and organic substances present on the surface of the base of the electrode film 11 or 31 and to improve the contact of the surface of the base with the electrode film 11 or 31.

In the step of forming the lower conductor layer 10 or the step of forming the upper conductor layer 30, inverse sputtering is employed, for example, as the method of removing the electrode films except the portions thereof located below the plating film. In this case, there is a possibility of damaging the top surface of the lower conductor layer 10, the upper conductor layer 30 or the dielectric film 20, depending on the conditions for the inverse sputtering. Methods for preventing this include removing the electrode films by wet etching, and adjusting the output and duration of inverse sputtering when the electrode films are removed by inverse sputtering. Alternatively, a film of a material (such as Ni) that is not used for the electrode films may be formed by plating, for example, on the plating film made of Cu, for example, and the electrode films may be selectively etched by inverse sputtering. Another alternative is that, a sputter film of Cu may be formed on the plating film made of Cu, for example. In this case, the crystal grain diameter of the sputter film is smaller than that of the plating film, and therefore it is possible to prevent the top surface of the lower conductor layer 10 or the upper conductor layer 30 from being damaged by inverse sputtering.

In the case of performing inverse sputtering after the dielectric film 20 is formed and before the electrode film 31 is formed, and/or in the case of removing the electrode films 31 and 32 by inverse sputtering to form the upper conductor layer 30, it is necessary to adjust the conditions for the inverse sputtering such as the output, gas flow rate, and process time so as to prevent a reduction in thickness of the dielectric film 20 and damage to the dielectric film 20.

[Second Embodiment]

A thin-film device of a second embodiment of the invention will now be described. FIG. 15 is a cross-sectional view of the thin-film device of the second embodiment. As shown in FIG. 15, the thin-film device 51 of the embodiment comprises the substrate 2 and the capacitor provided on the substrate 2. The capacitor 3 incorporates: the lower conductor layer 10 disposed on the substrate 2; a flattening film 52 made of a conductive material and disposed on the lower conductor layer 10; the dielectric film 20 disposed on the flattening film 52; and the upper conductor layer 30 disposed on the dielectric film 20. Differences between the thin-film device 51 of the second embodiment and the thin-film device 1 of the first embodiment are the existence of the flattening film 52 and the surface roughness of the lower conductor layer 10.

In the second embodiment the surface roughness in maximum height Rz of the top surface of the lower conductor layer 10 is not specifically defined. Instead, it is defined that the surface roughness in maximum height Rz of the top surface of the flattening film 52 is equal to or smaller than the thickness of the dielectric film 20 in the second embodiment. The reason is the same as the reason for making the surface roughness in maximum height Rz of the top surface of the lower conductor layer 10 equal to or smaller than the thickness of the dielectric film 20 in the first embodiment. The surface roughness in maximum height Rz of the top surface of the flattening film 52 is smaller than the surface roughness in maximum height Rz of the top surface of the lower conductor layer 10. The thickness of the flattening film 52 is determined according to the surface roughness in maximum height Rz of the top surface of the lower conductor layer 10, but preferably falls within a range of 0.05 to 2 μm inclusive.

The flattening film 52 is formed by any of electroplating, PVD and chemical vapor deposition (CVD). A film used as the flattening film 52 is one that exhibits a leveling effect, that is, an effect of flattening a surface having great projections and depressions, in combination with the material and the film-forming method. A film that exhibits the leveling effect is an Ni film formed by electroplating, for example. Therefore, an Ni film formed by electroplating may be used as the flattening film 52, for example. Alternatively, a layered film made up of an Ni film formed by electroplating and an Au film formed on the Ni film by electroplating may be used. To form the flattening film 52 by electroplating, a plating bath to which an additive having an effect of reducing the surface roughness of the plating film, such as a leveling agent or a brightener, is added may be used. Alternatively, a metal film formed by PVD or CVD may be used as the flattening film 52. In particular, bias sputtering or thermal CVD is suitable for the method of forming the flattening film 52.

Since the flattening film 52 of the embodiment is made of a conductive material, the flattening film 52 together with the lower conductor layer 10 makes up one of the electrodes of the capacitor 3.

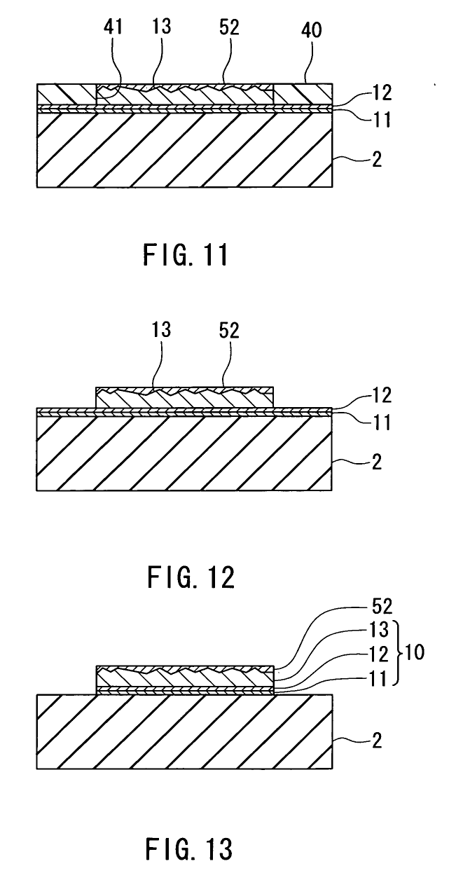

Reference is now made to FIG. 11 to FIG. 15 to describe a method of manufacturing the thin-film device 51 of the second embodiment. Although examples of materials and thicknesses of the layers are given in the following description, those examples are non-limiting for the method of the embodiment.

The method of manufacturing the thin-film device 51 of the second embodiment includes the steps up to the step of forming the frame 40 as shown in FIG. 3 that are the same as those of the first embodiment.

FIG. 11 illustrates the following step. In the step the plating film 13 and the flattening film 52 are formed one by one in the groove 41 of the frame 40 by electroplating using the electrode films 11 and 12 as electrodes. The material of the plating film 13 is Cu, for example. The thickness of the plating film 13 is 8 μm, for example. A film used as the flattening film 52 is, for example, an Ni film having a thickness of 1 μm or a layered film made up of an Ni film having a thickness of 1 μm and an Au film having a thickness of 0.1 μm. The flattening film 52 may be formed by PVD or CVD in place of electroplating.

In the step of FIG. 11, the thickness of the frame 40 may be 15 μm, for example, and the total thickness of the plating film 13 and the flattening film 52 may be 9 to 10 μm, for example. In this case, the top surface of the flattening film 52 is located lower than the top surface of the frame 40, so that the plating film 13 and the flattening film 52 are entirely placed in the groove 41 of the frame 40. It is thereby possible to control the shape of the lower conductor layer 10 with precision.

In the second embodiment the flattening film 52 is formed so that the surface roughness in maximum height Rz of the top surface of the flattening film 52 is equal to or smaller than the thickness of the dielectric film 20 that will be formed later. For example, when the dielectric film 20 having a thickness of 0.1 μm is to be formed, the flattening film 52 is formed so that the surface roughness in maximum height Rz of the top surface of the flattening film 52 is equal to or smaller than 0.1 μm.

It is not necessary to flatten the top surface of the flattening film 52 by polishing in such a case that the surface roughness in maximum height Rz of the top surface of the flattening film 52 is equal to or smaller than the thickness of the dielectric film 20 as described above without flattening the top surface of the flattening film 52 by polishing. It is also possible to make the surface roughness in maximum height Rz of the top surface of the flattening film 52 equal to or smaller than the thickness of the dielectric film 20 by flattening the top surface of the flattening film 52 through polishing. The method of polishing the top surface of the flattening film 52 is the same as the method of polishing the top surface of the plating film 13 of the first embodiment.

Next, as shown in FIG. 12, the frame 40 is removed. Next, as shown in FIG. 13, the electrode films 11 and 12 except portions thereof located below the plating film 13 are removed by dry etching or wet etching. As a result, the lower conductor layer 10 is formed of the remaining electrode films 11 and 12 and the plating film 13.

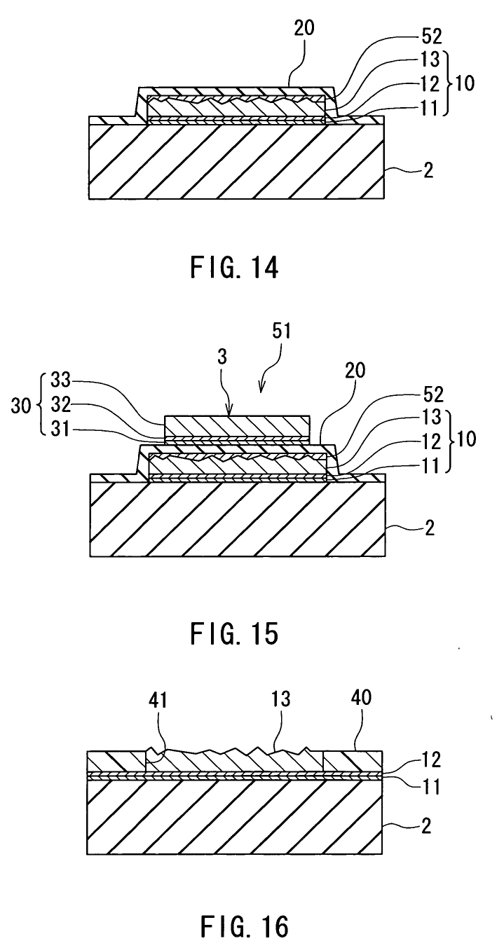

Next, as shown in FIG. 14, the dielectric film 20 is formed by sputtering, for example, to cover the top surface of the flattening film 52, the side surfaces of the lower conductor layer 10 and the top surface of the substrate 2. The thickness of the dielectric film 20 is 0.1 μm, for example.

Next, as shown in FIG. 15, the upper conductor layer 30 is formed in a region that is on the dielectric film 20 and that sandwiches the dielectric film 20 with the lower conductor layer 10. A method of forming the upper conductor layer 30 is the same as that of the first embodiment.

According to the second embodiment as thus described, the flattening film 52 is formed so that the surface roughness in maximum height Rz of the top surface of the flattening film 52 is equal to or smaller than the thickness of the dielectric film 20, and the dielectric film 20 is formed on the top surface of the flattening film 52. As a result, the second embodiment provides effects the same as those of the first embodiment. The remainder of configuration, function and effects of the second embodiment are similar to those of the first embodiment.

[Third Embodiment]

A thin-film device of a third embodiment of the invention will now be described. FIG. 21 is a cross-sectional view of the thin-film device of the third embodiment. As shown in FIG. 21, the thin-film device 61 of the embodiment comprises the substrate 2 and the capacitor provided on the substrate 2. The capacitor 3 incorporates: the lower conductor layer 10 disposed on the substrate 2; a flattening film 62 made of a conductive material and disposed on the lower conductor layer 10; the dielectric film 20 disposed on the flattening film 62; and the upper conductor layer 30 disposed on the dielectric film 20. Differences between the thin-film device 61 of the third embodiment and the thin-film device 1 of the first embodiment are the existence of the flattening film 62 and the surface roughness of the lower conductor layer 10.

In the third embodiment the surface roughness in maximum height Rz of the top surface of the lower conductor layer 10 is not specifically defined. Instead, it is defined that the surface roughness in maximum height Rz of the top surface of the flattening film 62 is equal to or smaller than the thickness of the dielectric film 20 in the third embodiment. The reason is the same as the reason for making the surface roughness in maximum height Rz of the top surface of the lower conductor layer 10 equal to or smaller than the thickness of the dielectric film 20 in the first embodiment. The surface roughness in maximum height Rz of the top surface of the flattening film 62 is smaller than the surface roughness in maximum height Rz of the top surface of the lower conductor layer 10. The thickness of the flattening film 62 is determined according to the surface roughness in maximum height Rz of the top surface of the lower conductor layer 10, but preferably falls within a range of 0.05 to 2 μm inclusive. The material and forming method of the flattening film 62 are the same as those of the flattening film 52 of the second embodiment.

Since the flattening film 62 of the embodiment is made of a conductive material, the flattening film 62 together with the lower conductor layer 10 makes up one of the electrodes of the capacitor 3.

Reference is now made to FIG. 16 to FIG. 21 to describe a method of manufacturing the thin-film device 61 of the third embodiment. Although examples of materials and thicknesses of the layers are given in the following description, those examples are non-limiting for the method of the embodiment.

The method of manufacturing the thin-film device 61 of the third embodiment includes the steps up to the step of forming the frame 40 as shown in FIG. 3 that are the same as those of the first embodiment.

FIG. 16 illustrates the following step. In the step the plating film 13 is formed in the groove 41 of the frame 40 by electroplating using the electrode films 11 and 12 as electrodes. The material of the plating film 13 is Cu, for example. The thickness of the plating film 13 is 8 μm, for example.

In the following step of the third embodiment, the top surface of the plating film 13 may be flattened by polishing but it is not necessarily required to flatten the top surface of the plating film 13. In the case of flattening the top surface of the plating film 13, the method of polishing the top surface of the plating film 13 is the same as that of the first embodiment.

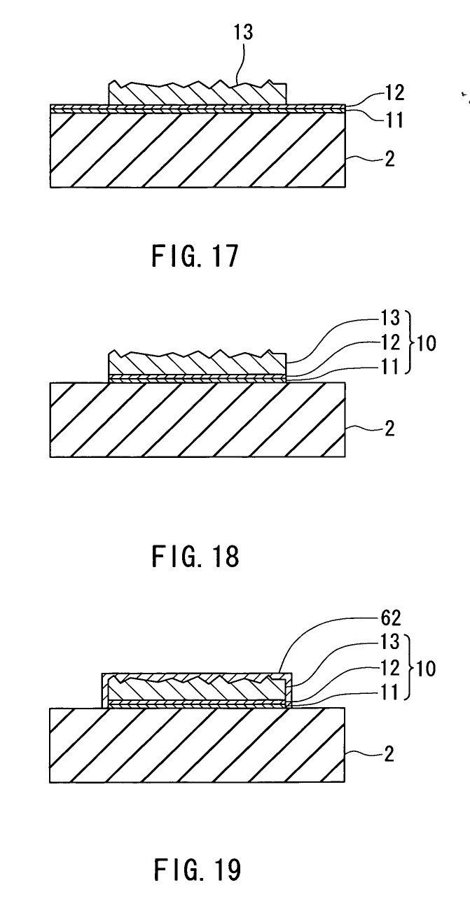

Next, as shown in FIG. 17, the frame 40 is removed. Next, as shown in FIG. 18, the electrode films 11 and 12 except portions thereof located below the plating film 13 are removed by dry etching or wet etching. As a result, the lower conductor layer 10 is formed of the remaining electrode films 11 and 12 and the plating film 13.

Next, as shown in FIG. 19, the flattening film 62 is formed by electroplating, for example, to cover the top and side surfaces of the lower conductor layer 10. A film used as the flattening film 62 is, for example, an Ni film having a thickness of 1 μm or a layered film made up of an Ni film having a thickness of 1 μm and an Au film having a thickness of 0.1 μm. The flattening film 62 may be formed by PVD or CVD in place of electroplating.

In the third embodiment the flattening film 62 is formed so that the surface roughness in maximum height Rz of the top surface of the flattening film 62 is equal to or smaller than the thickness of the dielectric film 20 that will be formed later. For example, when the dielectric film 20 having a thickness of 0.1 μm is to be formed, the flattening film 62 is formed so that the surface roughness in maximum height Rz of the top surface of the flattening film 62 is equal to or smaller than 0.1 m. In the step of FIG. 16, if the top surface of the plating film 13 is flattened by polishing, it is possible to further reduce the surface roughness of the top surface of the flattening film 62.

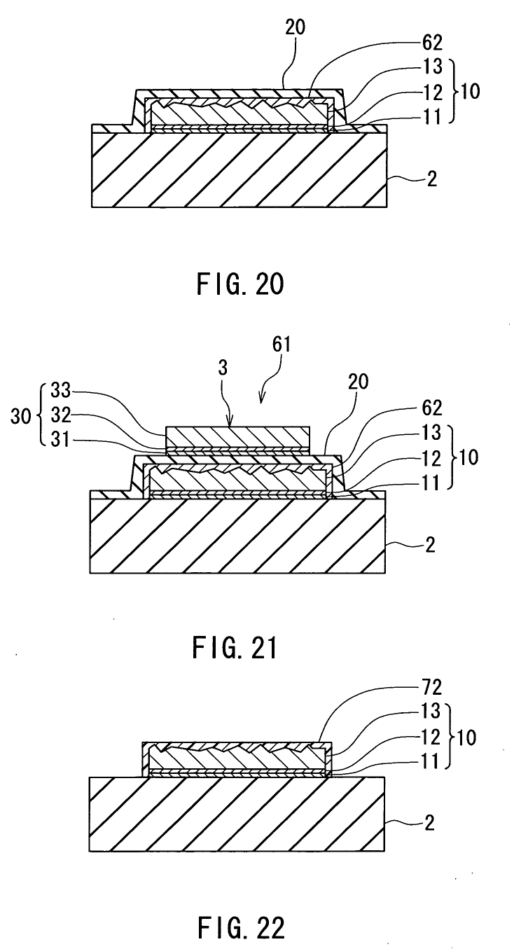

Next, as shown in FIG. 20, the dielectric film 20 is formed by sputtering, for example, to cover the top and side surfaces of the flattening film 62 and the top surface of the substrate 2. The thickness of the dielectric film 20 is 0.1 μm, for example.

Next, as shown in FIG. 21, the upper conductor layer 30 is formed in a region that is on the dielectric film 20 and that sandwiches the dielectric film 20 with the lower conductor layer 10. A method of forming the upper conductor layer 30 is the same as that of the first embodiment.

According to the third embodiment as thus described, the flattening film 62 is formed so that the surface roughness in maximum height Rz of the top surface of the flattening film 62 is equal to or smaller than the thickness of the dielectric film 20, and the dielectric film 20 is formed on the top surface of the flattening film 62. As a result, the third embodiment provides effects the same as those of the first embodiment. The remainder of configuration, function and effects of the third embodiment are similar to those of the first embodiment.

[Fourth Embodiment]

A thin-film device of a fourth embodiment of the invention will now be described. FIG. 24 is a cross-sectional view of the thin-film device of the fourth embodiment. As shown in FIG. 24, the thin-film device 71 of the embodiment comprises the substrate 2 and the capacitor 3 provided on the substrate 2. The capacitor 3 incorporates: the lower conductor layer 10 disposed on the substrate 2; a flattening film 72 made of an insulating material and disposed on the lower conductor layer 10; the dielectric film 20 disposed on the flattening film 72; and the upper conductor layer 30 disposed on the dielectric film 20. Differences between the thin-film device 71 of the fourth embodiment and the thin-film device 1 of the first embodiment are the existence of the flattening film 72 and the surface roughness of the lower conductor layer 10.

In the fourth embodiment the surface roughness in maximum height Rz of the top surface of the lower conductor layer 10 is not specifically defined. Instead, it is defined that the surface roughness in maximum height Rz of the top surface of the flattening film 72 is equal to or smaller than the thickness of the dielectric film 20 in the fourth embodiment. The reason is the same as the reason for making the surface roughness in maximum height Rz of the top surface of the lower conductor layer 10 equal to or smaller than the thickness of the dielectric film 20 in the first embodiment. The surface roughness in maximum height Rz of the top surface of the flattening film 72 is smaller than the surface roughness in maximum height Rz of the top surface of the lower conductor layer 10. The thickness of the flattening film 72 is determined according to the surface roughness in maximum height Rz of the top surface of the lower conductor layer 10, but preferably falls within a range of 0.05 to 2 μm inclusive.

The material of the flattening film 72 may be an organic material or an inorganic material. The material of the flattening film 72 is preferably a resin that is an organic material. In this case, the resin may be either a thermoplastic resin or a thermosetting resin. When an organic material such as a resin is used as the material of the flattening film 72, it is preferred that the organic material to form the flattening film is applied to the top of the lower conductor layer 10 while the material exhibits fluidity, and then the organic material is hardened to form the flattening film 72. The flattening film 72 may be made of a spin-on-glass (SOG) film. The flattening film 72 may be formed through an ink-jet technique.

Since the flattening film 72 of the embodiment is made of an insulating material, the flattening film 72 together with the dielectric film 20 makes up a dielectric layer disposed between a pair of electrodes of the capacitor 3.

Reference is now made to FIG. 22 to FIG. 24 to describe a method of manufacturing the thin-film device 71 of the fourth embodiment. Although examples of materials and thicknesses of the layers are given in the following description, those examples are non-limiting for the method of the embodiment.

The method of manufacturing the thin-film device 71 of the fourth embodiment includes the steps up to the step of forming the lower conductor layer 10 by using the electrode films 11 and 12 and the plating film 13 as shown in FIG. 18 that are the same as those of the third embodiment.

FIG. 22 illustrates the following step. In the step the flattening film 72 is formed to cover the top and side surfaces of the lower conductor layer 10. The material of the flattening film 72 is an organic material, for example. In this case, the flattening film 72 is formed by applying the organic material to form the flattening film to cover the top and side surfaces of the lower conductor layer 10 while the material exhibits fluidity, and then hardening the organic material.

In the fourth embodiment the flattening film 72 is formed so that the surface roughness in maximum height Rz of the top surface of the flattening film 72 is equal to or smaller than the thickness of the dielectric film 20 that will be formed later. For example, when the dielectric film 20 having a thickness of 0.1 μm is to be formed, the flattening film 72 is formed so that the surface roughness in maximum height Rz of the top surface of the flattening film 72 is equal to or smaller than 0.1 μm. In the step of FIG. 16, if the top surface of the plating film 13 is flattened by polishing, it is possible to further reduce the surface roughness of the top surface of the flattening film 72.

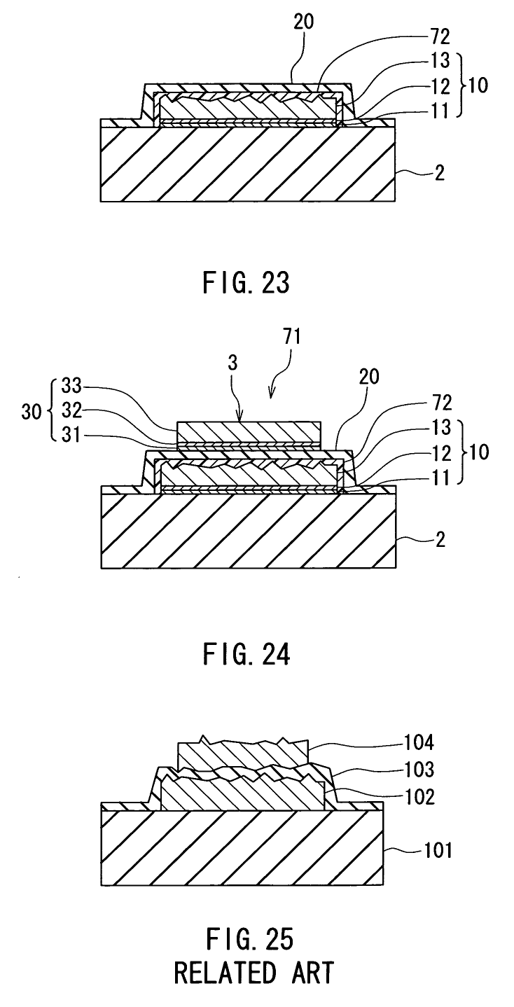

Next, as shown in FIG. 23, the dielectric film 20 is formed by sputtering, for example, to cover the top and side surfaces of the flattening film 72 and the top surface of the substrate 2. The thickness of the dielectric film 20 is 0.1 μm, for example.

Next, as shown in FIG. 24, the upper conductor layer 30 is formed in a region that is on the dielectric film 20 and that sandwiches the dielectric film 20 with the lower conductor layer 10. A method of forming the upper conductor layer 30 is the same as that of the first embodiment.

According to the fourth embodiment as thus described, the flattening film 72 is formed so that the surface roughness in maximum height Rz of the top surface of the flattening film 72 is equal to or smaller than the thickness of the dielectric film 20, and the dielectric film 20 is formed on the top surface of the flattening film 72. As a result, the fourth embodiment provides effects the same as those of the first embodiment. The remainder of configuration, function and effects of the fourth embodiment are similar to those of the first embodiment.

The present invention is not limited to the foregoing embodiments but may be practiced in still other ways. For example, in the thin-film device of the invention, a protection film may be provided on the upper conductor layer 30, or the upper conductor layer 30 may be exposed. Furthermore, one or more additional layers may be provided above the upper conductor layer 30.

In the invention, flattening processing by polishing or by forming a flattening film may be performed on the top surface of the upper conductor layer 30 as in the case of the top surface of the lower conductor layer 10, and then another dielectric film and conductor layer may be formed in this order on the top surface of the upper conductor layer 30 or the top surface of the flattening film. Furthermore, in such a way, flattening processing on the top surface of the conductor layer and formation of another dielectric film and conductor layer may be repeated. As a result, it is possible to form a capacitor having a configuration in which conductor layers and dielectric films are alternately stacked in a total of five or more layers.

The thin-film device of the invention may include elements other than a capacitor. Such elements may be passive elements such as inductors or active elements such as transistors. Such elements may be lumped-constant elements or distributed-constant elements.

The thin-film device of the invention may comprise terminals disposed on sides, the bottom surface or the top surface. The thin-film device of the invention may comprise through holes for connecting a plurality of conductor layers. The thin-film device of the invention may comprise conductor layers for wiring for connecting the lower conductor layer 10 or the upper conductor layer 30 to terminals or other elements. Alternatively, portions of the lower conductor layer 10 or the upper conductor layer 30 may also serve as the terminals, or the lower conductor layer 10 or the upper conductor layer 30 may be connected to the terminals via through holes.

If the thin-film device of the invention incorporates elements other than the capacitor, the thin-film device may be used as a variety of circuit components including a capacitor, such as LC circuit components, various filters including low-pass filters, high-pass filters and band-pass filters, diplexers, and duplexers.

The thin-film device of the invention is utilized for a mobile communications apparatus such as a cellular phone and a communications apparatus for a wireless LAN.

Obviously many modifications and variations of the present invention are possible in the light of the above teachings. It is therefore to be understood that within the scope of the appended claims the invention may be practiced otherwise than as specifically described.

What is claimed is:

1. A thin-film device comprising a capacitor, wherein:
the capacitor incorporates: a lower conductor layer; a dielectric film disposed on the lower conductor layer; and an upper conductor layer disposed on the dielectric film;
the dielectric film has a thickness that falls within a range of 0.02 to 1 μm inclusive and that is smaller than a thickness of the lower conductor layer; and
a surface roughness in maximum height of a top surface of the lower conductor layer is equal to or smaller than the thickness of the dielectric film.

2. A thin-film device comprising a capacitor, wherein:
the capacitor incorporates: a lower conductor layer; a flattening film made of a conductive material and disposed on the lower conductor layer; a dielectric film disposed on the flattening film; and an upper conductor layer disposed on the dielectric film;
the dielectric film has a thickness that falls within a range of 0.02 to 1 μm inclusive and that is smaller than a thickness of the lower conductor layer; and
a surface roughness in maximum height of a top surface of the flattening film is equal to or smaller than the thickness of the dielectric film.

3. A thin-film device comprising a capacitor, wherein:
the capacitor incorporates: a lower conductor layer; a flattening film made of an insulating material and disposed on the lower conductor layer; a dielectric film disposed on the flattening film; and an upper conductor layer disposed on the dielectric film;
the dielectric film has a thickness that falls within a range of 0.02 to 1 μm inclusive and that is smaller than a thickness of the lower conductor layer; and
a surface roughness in maximum height of a top surface of the flattening film is equal to or smaller than the thickness of the dielectric film.

4. A method of manufacturing a thin-film device comprising a capacitor, wherein: the capacitor incorporates a lower conductor layer, a dielectric film disposed on the lower conductor layer, and an upper conductor layer disposed on the dielectric film; and the dielectric film has a thickness that falls within a range of 0.02 to 1 μm inclusive and that is smaller than a thickness of the lower conductor layer, the method comprising the steps of:
forming the lower conductor layer by electroplating;
flattening a top surface of the lower conductor layer so that a surface roughness in maximum height of the top surface of the lower conductor layer is equal to or smaller than the thickness of the dielectric film;
forming the dielectric film on the lower conductor layer flattened; and
forming the upper conductor layer on the dielectric film.

5. The method according to claim 4, wherein the step of flattening the top surface of the lower conductor layer includes the step of polishing the top surface of the lower conductor layer.

6. The method according to claim 5, wherein chemical mechanical polishing is employed in the step of polishing the top surface of the lower conductor layer.

7. A method of manufacturing a thin-film device comprising a capacitor, wherein: the capacitor incorporates a lower conductor layer, a flattening film made of a conductive material and disposed on the lower conductor layer, a dielectric film disposed on the flattening film, and an upper conductor layer disposed on the dielectric film; the dielectric film has a thickness that falls within a range of 0.02 to 1 μm inclusive and that is smaller than a thickness of the lower conductor layer; and a surface roughness in maximum height of a top surface of the flattening film is equal to or smaller than the thickness of the dielectric film, the method comprising the steps of:
forming the lower conductor layer by electroplating;
forming the flattening film on the lower conductor layer;
forming the dielectric film on the flattening film; and
forming the upper conductor layer on the dielectric film.

8. The method according to claim 7, further comprising the step of polishing the top surface of the flattening film, the step being performed after the step of forming the flattening film and before the step of forming the dielectric film.

9. The method according to claim 7, further comprising the step of polishing a top surface of the lower conductor layer, the step being performed after the step of forming the lower conductor layer and before the step of forming the flattening film.

10. The method according to claim 7, wherein the flattening film is formed by any of electroplating, physical vapor deposition, and chemical vapor deposition in the step of forming the flattening film.

11. A method of manufacturing a thin-film device comprising a capacitor, wherein: the capacitor incorporates a lower conductor layer, a flattening film made of an insulating material and disposed on the lower conductor layer, a dielectric film disposed on the flattening film, and an upper conductor layer disposed on the dielectric film; the dielectric film has a thickness that falls within a range of 0.02 to 1 μm inclusive and that is smaller than a thickness of the lower conductor layer; and a surface roughness in maximum height of a top surface of the flattening film is equal to or smaller than the thickness of the dielectric film, the method comprising the steps of:
forming the lower conductor layer by electroplating;
forming the flattening film on the lower conductor layer;
forming the dielectric film on the flattening film; and
forming the upper conductor layer on the dielectric film.

12. The method according to claim 11, further comprising the step of polishing a top surface of the lower conductor layer, the step being performed after the step of forming the lower conductor layer and before the step of forming the flattening film.

13. The method according to claim 11, wherein, in the step of forming the flattening film, the flattening film is formed by applying a material to form the flattening film to a top of the lower conductor layer.
